(19) United States
(12) Patent Application Publication
(10) Pub. No.: US 2020/0325344 A1
(43) Pub. Date: Oct. 15, 2020

(54) AMPHIPHILIC COPOLYMERS AS SURFACE MODIFIERS FOR PRODUCTION OF IMPROVED CALCIUM CARBONATE POWDERS

(71) Applicant: IMERYS USA, INC., Roswell, GA (US)

(72) Inventors: Virendra SINGH, Cumming, GA (US); Kalena STOVALL, Atlanta, GA (US); Parvin GOLBAYANI, Dallas, TX (US); Richardo M. PEREZ, Cumming, GA (US); David A. TAYLOR, Marietta, GA (US); Christopher D. PAYNTER, Atlanta, GA (US); Douglas WICKS, Johns Creek, GA (US); Petra FRITZEN, Moers (DE); Anaelle GIRARD, Arles (FR)

(21) Appl. No.: 15/733,322

(22) PCT Filed: Dec. 21, 2018
(86) PCT No.: PCT/US2018/067115

§ 371 Date: Jun. 26, 2020

(30) Foreign Application Priority Data
Dec. 28, 2017 (EP) 17306956.8

(51) Int. Cl. C09C 1/02; C09C 3/10

(52) U.S. Cl. CPC C09C 1/021; C09C 3/10; C01P 2006/82; C01P 2004/62; C01P 2006/12; C01P 2004/51

(57) ABSTRACT

This disclosure describes a process for producing a surface-modified calcium carbonate, the process comprising contacting a calcium carbonate or precursor thereof with at least one amphiphilic copolymer comprising hydrophilic subunits and hydrophobic subunits, in which the hydrophilic subunits derive from at least one ethylenically-unsaturated compound comprising a carboxylic acid group or salt or derivative thereof; the hydrophobic subunits derive from at least one ethylenically-unsaturated compound comprising a hydrophobic group; and the amphiphilic copolymer has a hydrophilic-lipophilic balance ranging from about 1 to about 40. Surface-modified calcium carbonates obtained from the process are also described, as well as compositions containing the surface-modified calcium carbonates.

This application relates to materials technology in general and more specifically to a process for producing surface-modified calcium carbonates having improved properties. More particularly, this application discloses the preparation and use of surface-modified particles having a calcium carbonate core at least partially covered by an amphiphilic copolymer.

### BACKGROUND

Calcium carbonate (CaCO₃) is one of the most common and widely used minerals finding applications in various materials including rubbers, plastics, paints, papers, inks and even foods. Calcium carbonate particles come in many forms, such as precipitated calcium carbonate (PCC) and ground calcium carbonate (GCC). Modified versions of calcium carbonate are especially useful because the characteristics of this relatively-inexpensive mineral can be altered to replicate and replace other more expensive, rare or environmentally-unfriendly materials. In this context, much interest has been generated in the production and use of core-shell particles based on calcium carbonate as the core material, in which the shell of these core-shell particles is a functional surface coating.

The utility of surface-modified calcium carbonates can be greatly limited, however, due to the difficulty and expense in preparing them, as well as the challenges associated with adapting and tuning the characteristics of the functional surface coating for various difficult applications. The preparation of surface-modified calcium carbonates can limit their utility, because process steps such as drying and milling can be costly due to agglomeration and water-retention characteristics. Difficulties also arise in tuning the functional surface coating of surface-modified calcium carbonates to obtain optimal characteristics such as particle size distribution, surface area, moisture retention and oil-absorption.

### SUMMARY

The present inventors have recognized that a need exists to discover processes for efficiently preparing surface-modified calcium carbonates having optimal physical characteristics for specific applications. For example, a need exists to produce surface-modified calcium carbonates in large scale using a process in which the energy cost of performing critical steps such as drying and milling is reduced relative to known production methods. A need also exists to devise methods for producing surface-modified calcium carbonates whose physical characteristics can be fine tuned for specific applications such as use in polymers, paints, coatings, sealants and color modifiers.

The following disclosure describes the preparation and use of surface-modified particles having a calcium carbonate core at least partially covered by an amphiphilic copolymer.

Embodiments of the present disclosure, described herein such that one of ordinary skill in this art can make and use them, include the following:

(1) Some embodiments relate to a process for producing a surface-modified calcium carbonate, the process comprising contacting a calcium carbonate or precursor thereof with at least one amphiphilic copolymer comprising hydrophilic subunits and hydrophobic subunits, wherein: (a) the hydrophilic subunits derive from at least one ethylenically-unsaturated compound comprising a carboxylic acid group or salt or derivative thereof; (b) the hydrophobic subunits derive from at least one ethylenically-unsaturated compound comprising a hydrophobic group; and (c) the amphiphilic copolymer has a hydrophilic-lipophilic balance (HLB) value ranging from about 1 to about 40;

(2) Some embodiments relate to a surface-modified calcium carbonate obtained by the process (1) above; and

(3) Some embodiments relate to a composition comprising the surface-modified calcium carbonate of (2), wherein the composition is selected from the group consisting of a polymer, a paint, a coating, a sealant and a color modifying agent.

Additional objects, advantages and other features of the present disclosure will be set forth in part in the description that follows and in part will become apparent to those having ordinary skill in the art upon examination of the following or may be learned from the practice of the present disclosure. The present disclosure encompasses other and different embodiments from those specifically described below, and the details herein are capable of modifications in various respects without departing from the present disclosure. In this regard, the description herein is to be understood as illustrative in nature, and not as restrictive.

### BRIEF DESCRIPTION OF THE DRAWINGS

Embodiments of this disclosure are explained in the following description in view of figures that show:

FIG. 1 is a bar chart showing the nitrogen BET surface areas of surface-modified calcium carbonate particles versus the percent amount of amphiphilic copolymer added to a pre-carbonation milk of lime during production of PCC particles;

FIG. 2 is a bar chart showing the nitrogen BET surface areas of surface-modified calcium carbonate particles versus the percent amount of amphiphilic copolymer added to a post-carbonation suspension of during production of PCC particles;

FIG. 3 is a graph tracing the nitrogen BET surface areas and moisture uptakes of surface-modified calcium carbonate particles versus the percent amount of amphiphilic copolymer added to a pre-carbonation milk of lime during production of PCC particles.

### DETAILED DESCRIPTION

Embodiments of this disclosure includes various processes for producing surface-modified calcium carbonates, as well as compositions relating to these processes.

The terms “about” and “approximately” as used herein refer to being nearly the same as a referenced amount or value, and should be understood to encompass ±5% of the specified amount or value.

Some embodiments relate to a process for producing a surface-modified calcium carbonate. The process involves contacting a calcium carbonate or precursor thereof with at least one amphiphilic copolymer comprising hydrophilic subunits and hydrophobic subunits—in which the hydrophilic subunits derive from at least one ethylenically-unsaturated compound comprising a carboxylic acid group or salt or derivative thereof, and the hydrophobic subunits derive from at least one ethylenically-unsaturated compound comprising a hydrophobic group. In some embodiments the amphiphilic copolymer has a hydrophilic-lipophilic balance value ranging from about to about 40.

The process described above is advantageous, in part, because it allows the surface characteristics of the resulting surface-modified calcium carbonate to be fine tuned for specific applications. The surface-modified products can be adapted for specific applications by modulating the characteristics of amphiphilic copolymer. The term “amphiphilic copolymer,” as used herein, is intended to describe a copolymer having both hydrophilic (water loving) and lipophilic (oil loving) characteristics. In this disclosure the term “hydrophobic” is synonymous with the term “lipophilic.” Thus, the amphiphilic copolymer includes both hydrophilic and hydrophobic components.

The surface characteristics of the surface-modified calcium carbonates can be adjusted by altering the identity and proportion of the hydrophilic and hydrophobic subunits contained in the amphiphilic copolymer. Changing the identity and proportion of the hydrophilic and hydrophobic subunits can dramatically after not only the solubility characteristics of the amphiphilic copolymer, but can also dramatically affect both the structure (e.g., branching, crosslinking, etc.) of the amphiphilic copolymer and its ability to interact with, and bond to, the surface of calcium carbonate particles.

In designing the amphiphilic copolymers for particular applications, factors to consider in choosing the identity and proportion of the hydrophilic and hydrophobic subunits include not only the characteristics of the resulting functional surface coating, but also the solubility characteristics of the amphiphilic copolymer itself. As explained below in greater detail, the process of contacting the calcium carbonate (or precursor thereof) with the amphiphilic copolymer involves mixing a dispersion of these components. Thus, the ability to disperse the amphiphilic copolymer in a dispersion medium such as water is an important factor in processes of the present disclosure.

In some embodiments the amphiphilic copolymer has a hydrophilic-lipophilic balance value ranging from about 1 to about 40. The “hydrophilic-lipophilic balance” (abbreviated herein as “HLB”) is a measure of the degree to which a compound is hydrophilic or lipophilic, as determined for example by the methods Griffin and Davies which calculates values based ondifferent regions of the molecule. See “Classification of Surface-Active Agents by ‘HLB’,” Journal of the Society of Cosmetic Chemists, 1949, 1(5), 311-27; “The HLB System, a Time Saving Guide to Emulsifier Selection,” ICI Americas Inc., version 1980; Davies, J. P. & Rideal, E. K., “Interfacial Phenomena”, 2nd ed., p. 371 (Academic Press, London, 1963); Lin, I. J. & Marszall, L., Tenside Det, 15, 243 (1978); and O Boen Ho, J. Colloid. Interface Sci., 198, 249 (1998).

HLB values may be calculated using different methods depending upon the nature of the amphiphilic copolymer. For non-ionic (non-deprotonated) amphiphilic copolymers, HLB values may be calculated using the Griffin formula below. For ionic (deprotonated) amphiphilic copolymer, HLB values may be calculated using the Davies formula below.

HLB=20×MW_{H}/(MW_{H}+MW_{L})=wt % hydrophile/5 Griffin Formula
MW_{H}=mol. wt. of hydrophilic portion
MW_{L}=mol. wt. of hydrophobic portion

HLB=Σ(Hydrophilic group contributions)−Σ(hydrophobic group contributions Davies Formula

| group | contribution |
|---|---|
| —COO—Na+ | 19.1 |
| —CH₃ | 0.475 |
| —CH₂— | 0.475 |
| 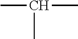 | 0.475 |
| —CH═ | 0.475 |
| —CH₂— Ø | 1.66 |
| 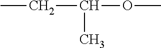 | 0.15 |

In some embodiments the amphiphilic copolymer may have an HLB value ranging from about 1 to about 40, or in some embodiments from about 3 to about 28. In other embodiments the amphiphilic copolymer may have an HLB value ranging from about 1 to about 3, or from about 3 to about 6, or from about 7 to about 9, or from about 8 to about 28, or from about 11 to about 18, or from about 12 to about 15.

In processes of the present disclosure the amphiphilic copolymer may be contacted with a calcium carbonate or with a precursor thereof. For example, the contacting step may involve the use of a mineral source of calcium carbonate such as a processed or unprocessed aragonite, calcite or dolomite—or may involve the use of a ground calcium carbonate (GCC) or precipitated calcium carbonate (PCC). Mineral sources of calcium carbonate may include, for example, limestone, chalk and marble, or mixtures thereof. When the core of the surface-modified calcium carbonate is based on PCC, the process may involve contacting the amphiphilic copolymer with a milk of lime comprising calcium hydroxide, a dispersion comprising the PCC, a filter cake comprising the PCC, or any combination thereof. In other embodiments the amphiphilic copolymer may be contacted with a powder comprising a processed or unprocessed calcium carbonate particles.

The ability to co-disperse the calcium carbonate and the amphiphilic copolymer in a liquid medium is important in some embodiments of the present disclosure. For example, in some embodiments the process includes the steps of contacting the amphiphilic copolymer with the calcium carbonate or precursor thereof in a liquid medium, to obtain a dispersion of the surface-modified calcium carbonate, and then removing the liquid medium from the dispersion to obtain a powder of the surface-modified calcium carbonate. The calcium carbonate or precursor thereof may be contacted with an aqueous dispersion of the amphiphilic copolymer or a salt thereof, or it may be contacted with a non-aqueous dispersion.

The liquid medium may contain a single substance or a mixture of substances. For example, the liquid medium may contain a single solvent or a mixture of solvents. The solvent may be capable of completely or partially dissolving the amphiphilic copolymer and/or may be capable of completely or partially dispersing the amphiphilic copolymer. In some embodiments the liquid medium may contain at least one solvent and at least one dispersing agent capable of promoting or enhancing dispersion of the amphiphilic copolymer and/or the calcium carbonate in the at least one solvent. The dispersing agent may be, for example, a surfactant, a flocculent, a clarifying agent, a detergent, an emulsifier, a wetting agent, a surface modifying agent, just to name a few, as well as other dispersing agents known in the art.

In some embodiments the liquid medium may be an aqueous dispersing medium. An aqueous dispersing medium may include water, or a mixture of water and at least one organic solvent. The dispersing medium may also contain water, at least one organic solvent and at least one dispersing agent. In some embodiments the dispersing medium is a homogeneous dispersing medium, while in other embodiments the dispersing medium is a heterogeneous dispersing medium.

The term “aqueous liquid” or “aqueous medium” as used herein describes a liquid containing water and at least one solvent. The term “solvent” as used herein means an organic solvent. For example, in some embodiments the liquid medium may contain at least one solvent selected from water, an ether-containing solvent, an alcohol-containing solvent, an ester-containing solvent, a ketone-containing solvent, an aromatic hydrocarbon-containing solvent, an aliphatic hydrocarbon-containing solvent, a polar protic solvent, a polar aprotic solvent, and mixtures thereof, just to name a few. Solvents of the liquid medium may also be compounds of mixed character, such as aliphatic-aromatic compounds, alcohol-ester compounds, alcohol-ether compounds, to name a few. Solvents of the liquid medium may also be halogenated compounds such as halogenated aromatic compounds and halogenated aliphatic compounds.

In some embodiments the liquid medium may include at least one solvent selected from acetone, acetonitrile, anisole, benzene, benzonitrile, benzyl alcohol, 1,3-butanediol, 2-butanone, tert-butanol, 1-butanol, 2-butanol, 2-(2-butoxyethoxy)ethyl acetate, 2-butoxyethyl acetate, butyl acetate, tert-butyl aceto acetate, tert-butyl methyl ether, carbon disulfide, carbon tetrachloride, chlorobenzene, 1-chlorobutane, chloroform, cyclohexane, cyclopentane, cyclopentyl methyl ether, decane, dibutyl ether, 1,2-dichlorobenzene, 1,2-dichloroethane, dichloromethane, diethyl ether, diethylene glycol butyl ether, diethylene glycol diethyl ether, diethylene glycol dimethyl ether, diethylene glycol monoethyl ether, diethylene glycol monoethyl ether acetate, diisopropyl ether, N,N-diisopropylethylamine, 1,2-dimethoxyethane, dimethyl carbonate, dimethyl sulfoxide, N,N-dimethylacetamide, 1,4-dioxane, 1,3-dioxolane, dodecane, ethanol, 2-ethoxyethanol, ethyl 3-ethoxyproprionate, ethyl acetate, ethylbenzene, ethylene carbonate, ethylene glycol, ethylene glycol butyl ether, ethylene glycol diethyl ether, 2-ethylhexyl acetate, formamide, glycerol, heptane, 2-heptanone, hexadecane, hexane, hexanol, isopentyl acetate, isopropyl acetate, isopropyl alcohol, methanol, 2-methoxyethanol, 2-methoxyethyl acetate, 1-methoxy-2-propanol, methyl acetate, methyl formate, 2-methylbutane, isoamyl alcohol, methylcyclohexane, 5-methyl-2-hexanone, 4-methyl-2-pentanone, isobutyl alcohol, 1-methyl-2-pyrrolidinone, 2-methyltetrahydrofuran, nitrobenzene, nitromethane, nonane, octane, 1-octanol, pentane, 1-pentanol, 2-pentanone, 3-pentanone, petroleum ether, piperidine, 1-propanol, 2-propanol, 2-propoxyethanol, propyl acetate, propylene carbonate, pyridine, 1,1,2,2-tetrachloroethane, tetrachloroethylene, tetrahydrofuran, toluene, 1,2,4-trichlorobenzene, 2,2,4-trimethylpentane, water, m-xylene, o-xylene, p-xylene, and mixtures thereof, just to name a few.

As explained above, the properties of the amphiphilic copolymer can be modulated by altering the identity and proportions of the hydrophilic and hydrophobic subunits. In some embodiments the hydrophilic subunits derive from at least one carboxyl group-containing vinyl monomer. The hydrophilic subunits may derive from at least one carboxyl group-containing monomer selected from a (meth)acrylic acid or salt or derivative thereof, an unsaturated polybasic acid or salt or derivative thereof, or a combination of these monomers.

In some embodiments the process is carried out using hydrophilic subunits that derive from at least one carboxyl group-containing monomer selected from acrylic acid, an alkylacrylic acid, an allyl malonic acid, an allyl succinic acid, a butenoic acid, a cinnamic acid, a citriconic acid, a crotonic acid, a glutaconic acid, an itaconic acid, a maleic acid, a fumaric acid, a mesaconic acid, a succinic acid and salts or derivatives thereof. The hydrophilic subunits may derive from maleic acid, a salt or derivative of maleic acid, or a combination thereof.

In some embodiments the hydrophobic group comprises an alkane group, an alkene group, an ether group, a sulfide group, an ester group, an imide group, a sultanate group, a phosphonate group, or combinations thereof. For example, the hydrophobic subunits may derive from an aliphatic or alicyclic olefin-containing compound, a (meth)acrylate compound, a vinyl aromatic compound, a vinyl ester compound, a (meth)acrylonitrile compound, a vinyl halide compound, a vinyl ether compound, a (meth)acrylamide compound, or a combination thereof. In some embodiments the hydrophobic subunits derive from at least one ethylenically-unsaturated compound selected from the group consisting of ethylene, propylene, 1-butene, 2-butene, isobutylene, diisobutylene, 1-pentene, 1-hexene, 1-heptene, 1-octene, 1-nonene, 1-decene, 2-pentene, 3-pentene, propylene tetramer; isobutylene trimer, 1,2-butadiene, 1,3-butadiene, 1,2-pentadiene, 1,3-pentadiene, 1,4-pentadiene, isoprene, 5-hexadiene, 2-methyl-5-propyl-1-hexene, 4-octene and 3,3-dimethyl-1-pentene.

In processes of the present disclosure the amphiphilic copolymer may further comprise at least one additional subunit derived from an ethylenically-unsaturated compound comprising a polar group. For example, the amphiphilic copolymer may further comprise at least one additional subunit derived from an ethylenically-unsaturated compound comprising a halide group, a hydroxyl group, a nitrile group, a nitro group, a sulfonic acid group or a phosphonic acid group. In some embodiments the amphiphilic copolymer further comprises at least one additional subunit derived from a sulfonic acid group-containing vinyl monomer, an acidic phosphate-containing vinyl monomer, a methylol-group-containing vinyl monomer, or a mixture thereof.

The amphiphilic copolymer may be a crosslinked copolymer or may be a non-crosslinked copolymer. Moreover, the amphiphilic copolymer may be branched or non-branched. The amphiphilic copolymer may be an alternating copolymer comprising alternating hydrophilic and hydrophobic subunits. In some embodiments the amphiphilic copolymer is a grafted copolymer, and in other embodiments the amphiphilic copolymer is not a grafted copolymer.

In some embodiments the amphiphilic copolymer comprises a polymer unit represented by the formula (I), (II) or (III):

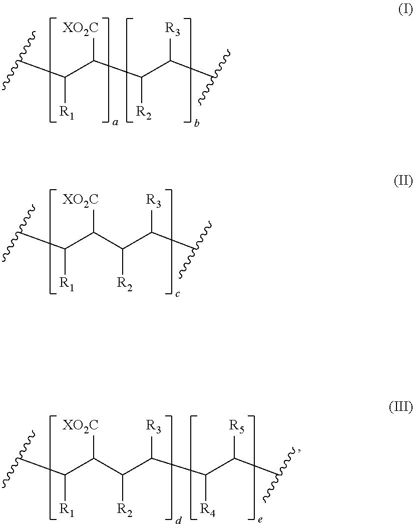

wherein: R₁ independently represents a hydrogen atom, an aliphatic group, an alicyclic group, an aromatic group, a heterocyclic group, or a carboxylic acid group or derivative or salt thereof, with the proviso that the R₁ group may form a ring with a carbon atom that is α, β or γ relative to the —CO₂X group or may represent a point of crosslinking; R₂ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphoric-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₃ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₄ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₅ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; X independently represents a hydrogen atom, an alkyl group, an amino group or a metal atom; a independently represents an integer ranging from 1 to 1000; b independently represents an integer ranging from 1 to 1000; c independently represents an integer ranging from 1 to 1000; d independently represents an integer ranging from 1 to 1000; and e independently represents an integer ranging from 1 to 1000.

The molar ratio of the hydrophilic subunits to the hydrophobic subunits in the amphiphilic copolymer may range from about 99:1 to about 1:99. In some embodiments the molar ratio of the hydrophilic subunits to the hydrophobic subunits may range from about 90:10 to about 10:90, or from about 85:15 to about 15:85, or from about 75:25 to about 25:75, or from about 65:35 to about 35:65, or from about 55:45 to about 45:55. The molar ratio of the hydrophilic subunits to the hydrophobic subunits may be adjusted to range from about 5:1 to about 1:5, or from about 4:1 to about 1:4, or from about 3:1 to about 1:3, or from about 2:1 to about 1:2, In other embodiments the molar ratio of the hydrophilic subunits to the hydrophobic subunits in the amphiphilic copolymer may range from about 1:1 to about 1:5, or from about 1:2 to about 1:4, or from about 1:2 to about 1:3.

In some embodiments the amphiphilic copolymer includes hydrophilic subunits derived from maleic acid or maleic anhydride and hydrophobic subunits derived from diisobutylene. The amphiphilic copolymer may also be chosen from a commercial copolymer containing hydrophilic subunits and hydrophobic subunits. For example, amphiphilic copolymers containing subunits derived from diisobutylene and a maleic acid or derivative thereof may include commercially-available polymers such as RHODOLINE® 111 (available from Solvay Novecare), TAMOL™ 731A (available from Dow Chemical Company) and ACUSOLTI 460 (available from Down Chemical Company), SOKOLAN® CP-9 (available from BASF) in which the molar ratio of the hydrophilic subunits (maleic acid or derivative thereof) to the hydrophobic subunits (diisobutylene) ranges from about 1:1 to about 1.5.

In addition to the amphiphilic copolymer, in some embodiment the process further comprises contacting the calcium carbonate or precursor thereof with at least one additional surface-modifying agent. The term “surface modification agent” generally refers to a reactive or non-reactive compound containing a hydrophobic and/or oleophobic group including at least one functional group that can chemically react or interact and bond with reactive groups present on the surface of the calcium carbonate. Bonding can be established via chemical bonding, e.g., covalent, including coordinative bonds (complexes) or ionic (salt-like) bonds of the functional group with the surface groups of the calcium carbonate, while interactions can include dipole-dipole interactions, polar interactions, hydrogen bridge bonds and van der Waals interactions.

Examples of suitable surface modification agents are mono- and polycarbonic acids, corresponding acid anhydrides, acid chlorides, esters and acid amides, alcohols, alkyl halides, amino acids, imines, nitriles, isonitriles, epoxy compounds, mono- and polyamine, dicarbonyl compounds, silanes and metal compounds, which have a functional group that can react with the surface groups of the calcium carbonate, as well as at least one hydrophobic and/or oleophobic group. In some embodiments the surface modification agents containing a hydrophobic and/or oleophobic group are silanes, carbonic acids, carbonic acid derivatives, like acid anhydrides and acid halides, in particular acid chlorides, alcohols, alkyl halides, like alkyl chlorides, alkyl bromides and alkyl iodides, wherein the alkyl residue can be substituted, in particular with fluorine. In some embodiments one or more surface modification agents can be used to surface modify the calcium carbonate. Both saturated and unsaturated fatty acids may be used as surface modification agents, and in some embodiments the number of carbon atoms may range from 8 carbons to 40 carbons.

The functional group contained within the surface modification agent can include carbonic acid groups, acid chloride groups, ester groups, nitrile and isonitrile groups, OH groups, alkyl halide groups, SH groups, epoxide groups, anhydride groups, acid amide groups, primary, secondary and tertiary amino groups, Si—OH groups or hydrolysable residues of silanes (Si—X groups described below) or C—H-acid groups, like dicarbonyl compounds. The surface modification agent can also encompass more than one such functional group, e.g., in amino acids or EDTA.

Suitable hydrophobic and/or oleophobic groups may include long-chain aliphatic hydrocarbon groups, e.g., with 1 to 40 or more carbon atoms, in particular alkyl groups, aromatic groups, or groups exhibiting at least one fluorine atom, wherein these are preferably hydrocarbon groups, in particular alkyl residues, with 1 to 20 or more carbon atoms and 1 to 41 fluorine atoms.

Suitable surface modification agents may include hydrolysable silanes with at least one non-hydrolysable hydrophobic and/or oleophobic group—such as hydrolysable silanes that exhibit at least one non-hydrolysable group, which is hydrophobic and/or oleophobic, in particular a group that contains at least one fluorine atom (fluorosilanes) or a long-chain aliphatic hydrocarbon group, e.g., with 1 to 30 carbon atoms, preferably an alkyl group, or an aromatic group.

In some embodiments the calcium carbonate is surface modified using a surface modification agent selected from an organosilane, an organotitanate, an organozirconate, an organoacid, an organoamine, an organothiol and a phosphinic compound. For example, the calcium carbonate or precursor thereof may also be contacted with at least one fatty acid compound or salt or derivative thereof—thereby producing a surface-modified calcium carbonate having a combination of the amphiphilic copolymer and the fatty acid compound as the surface covering. Fatty acids that may be used as the additional surface-modifying agent may include, for example, stearic acid, oleic acid, linoleic acid, linolenic acid, pinolenic acid, derivatives thereof and mixtures thereof. Other saturated and unsaturated fatty acids and derivatives thereof that are known to be effective surface modification agents for calcium carbonate may also be used as the additional surface modification agent.

As explained above, the fine tuning of the amphiphilic copolymer may involve modulating the proportion of the hydrophilic and hydrophobic subunits. In some embodiments a molar ratio of the hydrophilic subunits to the hydrophobic subunits in the amphiphilic copolymer ranges from about 20:80 to about 80:20. The proportion of the amphiphilic copolymer relative to the calcium carbonate may also be modulated to tune the properties of the surface-modified calcium carbonate. In some embodiments a mass ratio of the amphiphilic copolymer to the calcium carbonate or precursor thereof ranges from about 0.01:99.99 to about 5.0:95.0.

Embodiments of the present disclosure also relate to surface-modified calcium carbonates obtained by the processes described above. In some embodiments particles of the surface-modified calcium carbonate are in the form of a core-shell structure comprising a calcium carbonate core and a shell derived from the amphiphilic copolymer, said shell at least partially coating the calcium carbonate core, in which the shell is ionically bonded to the calcium carbonate core via deprotonated acid groups of the hydrophilic subunits.

Because the characteristics of the amphiphilic copolymer can be tuned to produce a wide variety of copolymers, the properties of the resulting surface-modified calcium carbonates can vary widely. For example, properties such as the surface area, particle size, moisture content, moisture uptake and oil absorption of the surface-modified calcium carbonates can be tuned for various different applications.

In some embodiments the surface-modified calcium carbonates may have a BET surface area of equal to or greater than 30.0 m²/g. In other embodiments the BET surface area may range from about 10 m²/g to about 100 m²/g, from about 100 m²/g to about 300 m²/g, from about 50 m²/g to about 150 m²/g, from about 10 m²/g to about 50 m²/g, from about 3 m²/g to about 25 m²/g, from about 150 m²/g to about 250 m²/g, from about 200 m²/g to about 300 m²/g, or from about 100 m²/g to about 200 m²/g. “BET surface area,” as used herein, refers to the technique for calculating specific surface area of physical absorption molecules according to Brunauer, Emmett, and Teller (“BET”) theory. BET surface area can be measured, for example, with an ASAP® 2460 Surface Area and Porosimetry Analyzer using nitrogen as the sorbent gas, available from Micromeritics Instrument Corporation (Norcross, Ga., USA).

In some embodiments the surface-modified calcium carbonates may have an average particle size (d₅₀) of equal to or less than 0.75 μm. In other embodiments the average particle size (d₅₀) may range from about 0.1 μm to about 2.0 μm, from 0.2 μm to about 0.8 μm, or from about 0.3 μm to about 0.6 μm. Particle size may be measured by any appropriate measurement technique now known to the skilled artisan or hereafter discovered. In one exemplary method, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 micrometers (μm or microns) to 704 μm. The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value.

In some embodiments the surface-modified calcium carbonates may have a moisture uptake of equal to or less than 2.0%. In other embodiments the moisture uptake may range from about 0.1% to about 10%, or from about 2% to about 5%. Moisture uptake is measured by placing about 10 g of a sample into a sealed, humidity-controlled chamber at a particular humidity for a period of 24 hours, and then weight sample to calculate the sample's % moisture uptake for a given humidity and time. In some embodiments the surface-modified calcium carbonates may have a moisture content of equal to or less than 35%. In other embodiments the moisture content may range from about 2% to about 45%, or from about 5% to about 40%, or from about 10% to about 30%. Moisture content is measured by placing a sample on an aluminum pan and then drying the sample and measuring the weight loss using a moisture analyzer.

Embodiments of the present disclosure also relate to compositions comprising the surface-modified calcium carbonates described above. Such compositions may include, for example, polymers, paints, coatings, sealants and pigments.

### EMBODIMENTS

Embodiment [1] of the present disclosure relates to a process for producing a surface-modified calcium carbonate, the process comprising contacting a calcium carbonate or precursor thereof with at least one amphiphilic copolymer comprising hydrophilic subunits and hydrophobic subunits, wherein: the hydrophilic subunits derive from at least one ethylenically-unsaturated compound comprising a carboxylic acid group or salt or derivative thereof; the hydrophobic subunits derive from at least one ethylenically-unsaturated compound comprising a hydrophobic group; and the amphiphilic copolymer has a hydrophilic-lipophilic balance value ranging from about 1 to about 40.

Embodiment [2] of the present disclosure relates to the surface-modified calcium carbonate of Embodiment [1], wherein: the hydrophilic subunits derive from maleic acid or maleic anhydride; and the hydrophobic subunits derive from diisobutylene.

Embodiment [3] of the present disclosure relates to the surface-modified calcium carbonate of Embodiments [1] and [2], wherein the calcium carbonate is a precipitated calcium carbonate or a ground calcium carbonate.

Embodiment [4] of the present disclosure relates to the surface-modified calcium carbonate of Embodiments [1]-[3], wherein the hydrophilic subunits derive from at least one carboxyl group-containing vinyl monomer.

Embodiment [5] of the present disclosure relates to the surface-modified calcium carbonate of Embodiments [1]-[4], wherein the hydrophilic subunits derive from at least one carboxyl group-containing monomer selected from the group consisting of a (meth)acrylic acid or salt or derivative thereof, an unsaturated polybasic acid or salt or derivative thereof, and mixtures thereof.

Embodiment [6] of the present disclosure relates to the surface-modified calcium carbonate of Embodiments [1]-[5], wherein the hydrophilic subunits derive from at least one carboxyl group-containing monomer selected from the group consisting of acrylic acid, an alkylacrylic acid, an allyl malonic acid, an allyl succinic acid, a butenoic acid, a cinnamic acid, a citriconic acid, a crotonic acid, a glutaconic acid, an itaconic acid, a maleic acid, a fumaric acid, a mesaconic acid, a succinic acid and salts or derivatives thereof.

Embodiment [7] of the present disclosure relates to the surface-modified calcium carbonate of Embodiments [1]-[6], wherein the hydrophilic subunits derive from maleic acid, a salt or derivative of maleic acid, or a combination thereof.

Embodiment [8] of the present disclosure relates to the surface-modified calcium carbonate of Embodiments [1]-[7], wherein the hydrophobic group comprises an alkane group, an alkene group, an ether group, a sulfide group, an ester group, an imide group, a sulfonate group, a phosphonate group, or combinations thereof.

Embodiment [9] of the present disclosure relates to the surface-modified calcium carbonate of Embodiments [1]-[8], wherein the hydrophobic subunits derive from an aliphatic or alicyclic olefin-containing compound, a (meth)acrylate compound, a vinyl aromatic compound, a vinyl ester compound, a (meth)acrylonitrile compound, a vinyl halide compound, a vinyl ether compound, a (meth)acrylamide compound, or a combination thereof.

Embodiment [10] of the present disclosure relates to the surface-modified calcium carbonate of Embodiments [1]-[9], wherein the hydrophobic subunits derive from at least one ethylenically-unsaturated compound selected from the group consisting of ethylene, propylene, 1-butene, 2-butene, isobutylene, diisobutylene, 1-pentene, 1-hexene, 1-heptene, 1-octene, 1-nonene, 1-decene, 2-pentene, 3-pentene, propylene tetramer; isobutylene trimer, 1,2-butadiene, 1,3-butadiene, 1,2-pentadiene, 1,3-pentadiene, 1,4-pentadiene, isoprene, 5-hexadiene, 2-methyl-5-propyl-1-hexene, 4-octene and 3,3-dimethyl-1-pentene.

Embodiment [11] of the present disclosure relates to the surface-modified calcium carbonate of Embodiments [1]-[10], wherein the amphiphilic copolymer further comprises at least one additional subunit derived from an ethylenically-unsaturated compound comprising a polar group.

Embodiment [12] of the present disclosure relates to the surface-modified calcium carbonate of Embodiments [1]-[11], wherein the amphiphilic copolymer further comprises at least one additional subunit derived from an ethylenically-unsaturated compound comprising a halide group, a hydroxyl group, a nitrile group, a nitro group, a sulfonic acid group or a phosphonic acid group.

Embodiment [13] of the present disclosure relates to the surface-modified calcium carbonate of Embodiments [1]-[12], wherein the amphiphilic copolymer further comprises at least one additional subunit derived from a sulfonic acid group-containing vinyl monomer, an acidic phosphate-containing vinyl monomer, a methylol-group-containing vinyl monomer, or a mixture thereof.

Embodiment [14] of the present disclosure relates to the surface-modified calcium carbonate of Embodiments [1]-[13], wherein the amphiphilic copolymer is a crosslinked copolymer.

Embodiment [15] of the present disclosure relates to the surface-modified calcium carbonate of Embodiments [1]-[14], wherein the amphiphilic copolymer is an alternating copolymer comprising alternating hydrophilic and hydrophobic subunits.

Embodiment [16] of the present disclosure relates to the surface-modified calcium carbonate of Embodiments [1]-[15], wherein the amphiphilic copolymer comprises a polymer unit represented by the formula (I), (II) or (Ill):

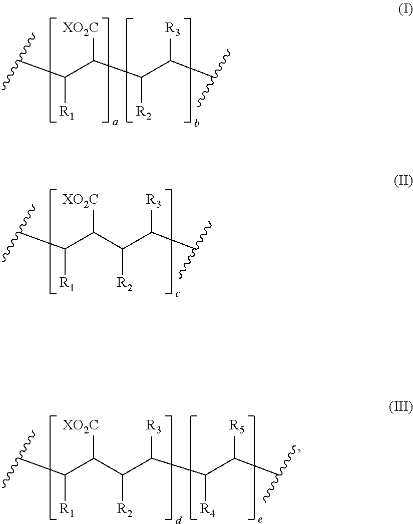

wherein: R₁ independently represents a hydrogen atom, an aliphatic group, an alicyclic group, an aromatic group, a heterocyclic group, or a carboxylic acid group or derivative or salt thereof, with the proviso that the R₁ group may form a ring with a carbon atom that is α, β or γ relative to the —CO₂X group or may represent a point of crosslinking; R₂ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₃ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₄ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; R₅ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking; X independently represents a hydrogen atom, an alkyl group, an amino group or a metal atom; a independently represents an integer ranging from 1 to 1000; b independently represents an integer ranging from 1 to 1000; c independently represents an integer ranging from 1 to 1000: d independently represents an integer ranging from 1 to 1000; and e independently represents an integer ranging from 1 to 1000.

Embodiment [17] of the present disclosure relates to the surface-modified calcium carbonate of Embodiments [1][16], comprising contacting the amphiphilic copolymer with at least one of: a milk of lime comprising calcium hydroxide; a dispersion comprising a precipitated calcium carbonate; a filter cake comprising a precipitated calcium carbonate; and a powder comprising calcium carbonate particles.

Embodiment [18] of the present disclosure relates to the surface-modified calcium carbonate of Embodiments [1]-[17], comprising: contacting the amphiphilic copolymer with the calcium carbonate or precursor thereof in a liquid medium, to obtain a dispersion of the surface-modified calcium carbonate; and removing the liquid medium from the dispersion to obtain a powder of the surface-modified calcium carbonate.

Embodiment [19] of the present disclosure relates to the surface-modified calcium carbonate of Embodiments [1]-[18], wherein the calcium carbonate or precursor thereof is contacted with an aqueous dispersion of the amphiphilic copolymer or a salt thereof.

Embodiment [20] of the present disclosure relates to the surface-modified calcium carbonate of Embodiments [1]-[19], further comprising contacting the calcium carbonate or precursor thereof with at least one additional surface-modifying agent.

Embodiment [21] of the present disclosure relates to the surface-modified calcium carbonate of Embodiments [1]-[20], further comprising contacting the calcium carbonate or precursor thereof with at least one fatty acid compound or salt or derivative thereof.

Embodiment [22] of the present disclosure relates to the surface-modified calcium carbonate of Embodiments [1]-[21], wherein a molar ratio of the hydrophilic subunits to the hydrophobic subunits in the amphiphilic copolymer ranges from about 20:80 to about 80:20.

Embodiment [23] of the present disclosure relates to the surface-modified calcium carbonate of Embodiments [1]-[22], wherein a mass ratio of the amphiphilic copolymer to the calcium carbonate or precursor thereof ranges from about 0.01:99.99 to about 5.0:95.0.

Embodiment [24] of the present disclosure relates to a surface-modified calcium carbonate obtained by the process of Embodiments [1]-[23].

Embodiment [25] of the present disclosure relates to the surface-modified calcium carbonate of Embodiment [24], wherein: particles of the surface-modified calcium carbonate are in the form of a core-shell structure comprising a calcium carbonate core and a shell derived from the amphiphilic copolymer, said shell at least partially coating the calcium carbonate core; and the shell is ionically bonded to the calcium carbonate core via deprotonated acid groups of the hydrophilic subunits.

Embodiment [26] of the present disclosure relates to the surface-modified calcium carbonate of Embodiments [24] and [25], having a BET surface area of equal to or greater than 30.0 m²/g.

Embodiment [27] of the present disclosure relates to the surface-modified calcium carbonate of Embodiments [24]-[26], having an average particle size (d₅₀) of equal to or less than 0.75 μm.

Embodiment [28] of the present disclosure relates to the surface-modified calcium carbonate of Embodiments [24]-[27], having a moisture uptake of equal to or less than 2.0%.

Embodiment [29] of the present disclosure relates to the surface-modified calcium carbonate of Embodiments [24]-[28], having a moisture content of equal to or less than 35%.

Embodiment [30] of the present disclosure relates to a composition, comprising the surface-modified calcium carbonate of Embodiments [24]-[29], wherein the composition is selected from the group consisting of a polymer, a paint, a coating, a sealant and a color modifying agent.

### Examples

The following examples are provided for illustration purposes only and in no way limit the scope of the present disclosure. Embodiments of the present disclosure may employ the use of different or additional components compared to the materials illustrated below, such as other calcium carbonates, other amphiphilic copolymer, and other processing conditions.

### Study Overview

In the examples illustrated below, the particle and surface characteristics of surface-modified calcium carbonates are altered and controlled by modulating the proportion and the order of addition of an amphiphilic copolymer used as a surface-modifying agent during formation of precipitated calcium carbonates.

### Materials

A mineral calcium carbonate (limestone) supplied by Imerys Carbonates was used in the production of precipitated calcium carbonates (PCC). Commercial samples of RHODOLINE® 111 (diisobutylene-maleic anhydride copolymer) were supplied by Solvay.

### Effect of Amphiphilic Copolymer on the Production of Precipitated Calcium Carbonates

The effect of an amphiphilic copolymer of the present disclosure on the production of precipitated calcium carbonates (PCCs) was explored by adding different proportions of RHODOLINE® 111 to different stages of the production process.

To obtain a reference PCC, a mineral calcium carbonate (limestone) was calcined to obtain gaseous calcium oxide (calcined lime) that was slaked with water to obtain a milk of lime. The milk of lime was then carbonated with carbon dioxide to obtain a suspension of PCC. The suspension of PCC was filtered and dried to obtain PCC particles designated below as the Reference Sample. PCC particles of the Reference Sample were measured to determine the particle and surface characteristics, as summarized in Tables 1 and 2 below.

TABLE 1
Particle Size Characteristics of Non-Surface-Modified
PCC Particles Used as the Reference Sample
Reference Sample

| | | |
|---|---|---|
| Sedigraph | D₅₀ | 2.56 μm |

| | | | |
|---|---|---|---|
| PSD | >5 | μm | 3.7% |
| | <2 | μm | 16.1% |
| | <1 | μm | 1.7% |
| | <0.5 | μm | 0.9% |

| | |
|---|---|
| Steepness | 0.76 |
| (D₇₀/D₃₀) | |

TABLE 2
Surface Characteristics of Non-Surface-Modified
PCC Particles Used as the Reference Sample
Reference Sample

| | | | |
|---|---|---|---|
| N₂ BET | 5 point | m²/g | 17.36 |
| SA | | C. | 328 |

| | | |
|---|---|---|
| MPU | 100% RH/24 hrs | 3.60 wt % |

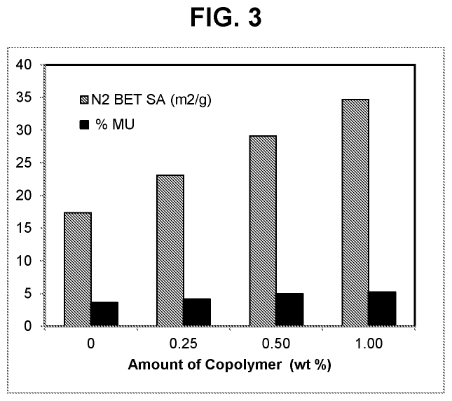

To study the effects of the amphiphilic copolymer in the surface modification of PCC, the procedure described above for the preparation of PCC was modified such that RHODOLINE® 111 was added at different stages of the procedure. In one set of experiments, different proportions of the amphiphilic copolymer were added to the milk of lime in order to study the effects of pre-carbonation addition of the amphiphilic copolymer during FCC production. The results of the pre-carbonation addition of RHODOLINE® 111 are summarized in FIG. 3 and Tables 3 and 5 below. In another set of experiments, different proportions of the amphiphilic copolymer were added to the suspension of PCC. The results of the post-carbonation addition of RHODOLINE® 111 are summarized in Tables 4 and 6 below.

As shown in Table 3, addition of an amphiphilic copolymer to the milk of lime prior to carbonation resulted in the formation of surface-modified calcium carbonates having significantly reduced particle sizes relative to the PCC particles of the Reference Sample. The particle size characteristics were found to be dose dependent, such that the particle size (D₅₀) and steepness (D₇₀/D₃₀) of the surface-modified calcium carbonates were minimized by using lower doses of 0.25 mass % and 0.5 mass % of RHODOLINE® 111.

TABLE 3
Effect of Pre-Carbonation Addition of Amphiphilic Copolymer
on Particle Characteristics of Surface-Modified PCC

| | | | Reference | Ex. 1 | Ex. 2 | Ex. 3 |
|---|---|---|---|---|---|---|
| | | | Sample | 0.25 | 0.50 | 1.0 |
| Amount of Copolymer^{a)} | | | n/a | mass % | mass % | mass % |
| Sedigraph | D₅₀ | | 2.56 μm | 0.87 μm | 0.91 μm | 1.06 μm |
| PSD | >5 | μm | 3.7% | 0.2% | 0.8% | 0.6% |
| | <2 | μm | 16.1% | 92.7% | 89.6% | 91.5% |
| | <1 | μm | 1.7% | 58% | 28.2% | 46.6% |
| | <0.5 | μm | 0.9% | 28.2% | 29.8% | 20% |

| | | | | |
|---|---|---|---|---|
| Steepness | 0.76 | 0.43 | 0.39 | 0.51 |
| (D₇₀/D₃₀) | | | | |

^{a)}RHODOLINE ® 111

TABLE 4
Effect of Post-Carbonation Addition of Amphiphilic Copolymer
on Particle Characteristics of Surface-Modified PCC

| | | Reference | | | | |
|---|---|---|---|---|---|---|
| | | Sample | Ex. 4 | Ex. 5 | Ex. 6 | Ex. 7 |
| Amount of Copolymer^{a)} | | n/a | 0.25 | 0.50 | 1.0 | 2.0 |
| | | | mass % | mass % | mass % | mass % |
| Sedigraph | D₅₀ | 2.56 μm | 0.9 μm | 0.9 μm | 0.93 μm | 0.95 μm |
| PSD | >5 μm | 3.7% | 0.1% | 0.2% | 0.3% | 1.3% |
| | <2 μm | 16.1% | 95.1% | 95.4% | 95.8% | 94.7% |
| | <1 μm | 1.7% | 57.4% | 57.6% | 55.9% | 54.3% |
| | <0.5 μm | 0.9% | 26.6% | 27.4% | 24.2% | 23.9% |
| | Steepness | 0.76 | 0.48 | 0.48 | 0.52 | 0.52 |
| | (D₇₀/D₃₀) | | | | | |

^{a)}RHODOLINE ® 111

As shown in Table 4, addition of the amphiphilic copolymer to the suspension of PCC after carbonation also resulted in the formation of surface-modified calcium carbonates also having reduced particle sizes relative to the PCC particles of the Reference Sample. The particle size characteristics were found to be dose dependent, such that the particle size (D₅₀) and steepness (D₇₀/D₃₀) of the surface-modified calcium carbonates were minimized by using lower doses of 0.25 mass % and 0.5 mass % of RHODOLINE® 111.

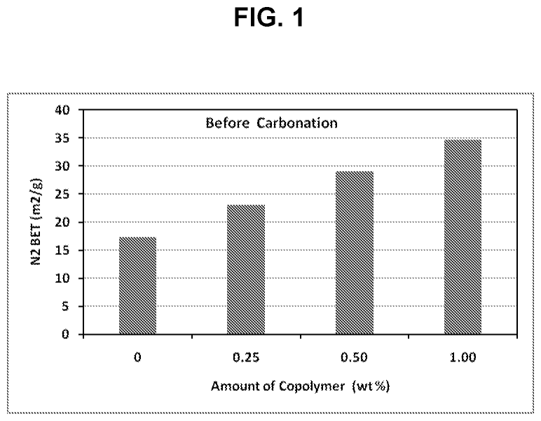

As shown in Table 5, addition of an amphiphilic copolymer to the milk of lime prior to carbonation resulted in the formation of surface-modified calcium carbonates having significantly increased surface area and moisture uptake relative to the PCC particles of the Reference Sample. The BET surface area and moisture uptake were found to be dose dependent, such that increasing the proportion of the amphiphilic copolymer caused an increase in both the BET surface area and the moisture uptake of surface-modified calcium carbonate particles. FIG. 1 is a bar chart showing the nitrogen BET surface areas of surface-modified calcium carbonate particles versus the percent amount of amphiphilic copolymer added to a pre-carbonation milk of lime during production of PCC particles.

TABLE 5
Effect of Pre-Carbonation Addition of Amphiphilic Copolymer
on Particle Characteristics of Surface-Modified PCC

| | | | Reference | | | |
|---|---|---|---|---|---|---|
| | | | Sample | Ex. 8 | Ex. 9 | Ex. 10 |
| Amount of Copolymer^{a)} | | | n/a | 0.25 | 0.50 | 1.0 |
| | | | | mass % | mass % | mass % |
| N₂ BET | 5 point | m²/g | 17.36 | 23.10 | 29.08 | 34.66 |
| SA | | C | 328 | 168.9 | 112.3 | 78.7 |

| | | | | | |
|---|---|---|---|---|---|
| MPU | 100% RH/24 hrs | 3.60 wt % | 4.11 wt % | 4.92 wt % | 5.21 wt % |

^{a)}RHODOLINE ® 111

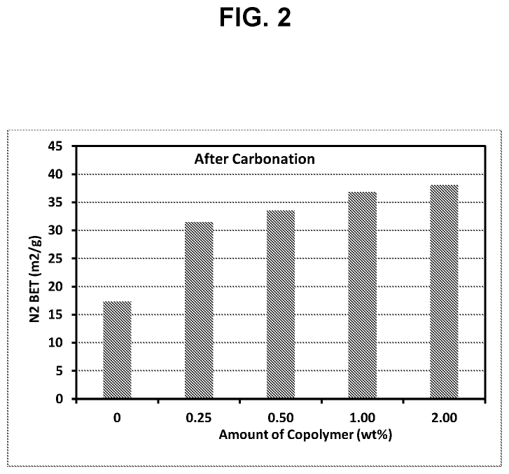

As shown in Table 6 and FIG. 2, addition of an amphiphilic copolymer to the suspension of PCC after carbonylation also resulted in the formation of surface-modified calcium carbonates having significantly increased surface area relative to the PCC particles of the Reference Sample. The BET surface area was found to be dose dependent, such that increasing the proportion of the amphiphilic copolymer caused an increase in the BET surface areas of surface-modified calcium carbonate particles. The moisture uptake was also found to be dose dependent. However, surprisingly, an opposite dose dependence was observed relative to the pre-carbonylation data in Table 5—such that increasing the proportion of the amphiphilic copolymer causes the moisture uptake of the surface-modified calcium carbonate particles to decrease. In Example 11, the post-carbonylation addition of 0.25 mass % of RHODOLINE® 111 produced surface-modified calcium carbonate particles have a moisture uptake (MPU) of 4.83 wt. %. Increasing the proportion of the added RHODOLINE® 111 in Examples 12-14 produced surface-modified calcium carbonate particles have progressively lower moisture uptake values of 4.37 wt. %, 4.09 wt. % and 3.34 wt. % respectively.

TABLE 6
Effect of Post-Carbonation Addition of Amphiphilic Copolymer
on Particle Characteristics of Surface-Modified PCC

| | | | Reference | | | | |
|---|---|---|---|---|---|---|---|
| | | | Sample | Ex. 11 | Ex. 12 | Ex. 13 | Ex. 14 |
| Amount of Copolymer^{a)} | | | n/a | 0.25 | 0.50 | 1.0 | 2.0 |
| | | | | mass % | mass % | mass % | mass % |
| N₂ BET | 5 point | m²/g | 17.36 | 31.49 | 33.55 | 36.87 | 38.13 |
| SA | | C | 328 | 140.4 | 91.3 | 60.4 | 44.9 |

| | | | | | | |
|---|---|---|---|---|---|---|
| MPU | 100% RH/24 hrs | 3.60 wt % | 4.83 wt % | 4.37 wt % | 4.09 wt % | 3.34 wt % |

^{a)}RHODOLINE ® 111

Embodiments of the present disclosure may be as defined in the following numbered paragraphs:
1. A process for producing a surface-modified calcium carbonate, the process comprising contacting a calcium carbonate or precursor thereof with at least one amphiphilic copolymer comprising hydrophilic subunits and hydrophobic subunits, wherein:
   the hydrophilic subunits derive from at least one ethylenically-unsaturated compound comprising a carboxylic acid group or salt or derivative thereof;
   the hydrophobic subunits derive from at least one ethylenically-unsaturated compound comprising a hydrophobic group; and
   the amphiphilic copolymer has a hydrophilic-lipophilic balance value ranging from about 1 to about 40.
2. The process of Paragraph 1, wherein:
   the hydrophilic subunits derive from maleic acid or maleic anhydride; and
   the hydrophobic subunits derive from diisobutylene.
3. The process of Paragraph 1, wherein the calcium carbonate is a precipitated calcium carbonate or a ground calcium carbonate.
4. The process of Paragraph 1, wherein the hydrophilic subunits derive from at least one carboxyl group-containing vinyl monomer.
5. The process of Paragraph 1, wherein the hydrophilic subunits derive from at least one carboxyl group-containing monomer selected from the group consisting of a (meth)acrylic acid or salt or derivative thereof, an unsaturated polybasic acid or salt or derivative thereof, and mixtures thereof.
6. The process of Paragraph 1, wherein the hydrophilic subunits derive from at least one carboxyl group-containing monomer selected from the group consisting of acrylic acid, an alkylacrylic acid, an allyl malonic acid, an allyl succinic acid, a butenoic acid, a cinnamic acid, a citriconic acid, a crotonic acid, a glutaconic acid, an itaconic acid, a maleic acid, a fumaric acid, a mesaconic acid, a succinic acid and salts or derivatives thereof.
7. The process of Paragraph 1, wherein the hydrophilic subunits derive from maleic acid, a salt or derivative of maleic acid, or a combination thereof.
8. The process of Paragraph 1, wherein the hydrophobic group comprises an alkane group, an alkene group, an ether group, a sulfide group, an ester group, an imide group, a sulfonate group, a phosphonate group, or combinations thereof.
9. The process of Paragraph 1, wherein the hydrophobic subunits derive from an aliphatic or alicyclic olefin-containing compound, a (meth)acrylate compound, a vinyl aromatic compound, a vinyl ester compound, a (meth)acrylonitrile compound, a vinyl halide compound, a vinyl ether compound, a (meth)acrylamide compound, or a combination thereof.
10. The process of Paragraph 1, wherein the hydrophobic subunits derive from at least one ethylenically-unsaturated compound selected from the group consisting of ethylene, propylene, 1-butene, 2-butene, isobutylene, diisobutylene, 1-pentene, 1-hexene, 1-heptene, 1-octene, 1-nonene, 1-decene, 2-pentene, 3-pentene, propylene tetramer; isobutylene trimer, 1,2-butadiene, 1,3-butadiene, 1,2-pentadiene, 1,3-pentadiene, 1,4-pentadiene, isoprene, 5-hexadiene, 2-methyl-5-propyl-1-hexene, 4-octene and 3,3-dimethyl-1-pentene.
11, The process of Paragraph 1, wherein the amphiphilic copolymer further comprises at least one additional subunit derived from an ethylenically-unsaturated compound comprising a polar group.
12. The process of Paragraph 1, wherein the amphiphilic copolymer further comprises at least one additional subunit derived from an ethylenically-unsaturated compound comprising a halide group, a hydroxyl group, a nitrile group, a nitro group, a sulfonic acid group or a phosphonic acid group.
13. The process of Paragraph 1, wherein the amphiphilic copolymer further comprises at least one additional subunit derived from a sulfonic acid group-containing vinyl monomer, an acidic phosphate-containing vinyl monomer, a methylol-group-containing vinyl monomer, or a mixture thereof.
14. The process of Paragraph 1, wherein the amphiphilic copolymer is a crosslinked copolymer.
15, The process of Paragraph 1, wherein the amphiphilic copolymer is an alternating copolymer comprising alternating hydrophilic and hydrophobic subunits.
16. The process of Paragraph 1, wherein the amphiphilic copolymer comprises a polymer unit represented by the formula (I), (II) or (Ill):

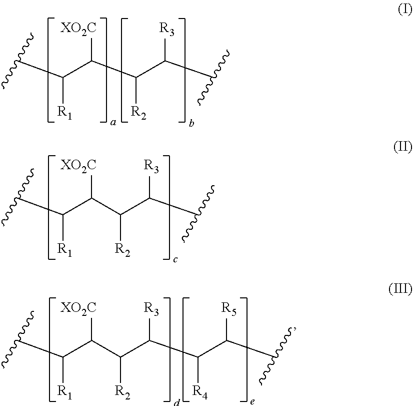

wherein:
R₁ independently represents a hydrogen atom, an aliphatic group, an alicyclic group, an aromatic group, a heterocyclic group, or a carboxylic acid group or derivative or salt thereof, with the proviso that the R₁ group may form a ring with a carbon atom that is α, β or γ relative to the —CO₂X group or may represent a point of crosslinking;
R₂ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₃ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₄ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₅ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group; a phosphonate or phosphonic-containing group, a nitrile-containing group, a nitro-containing group; a hydroxyl-containing group, or a halide-containing group, with the proviso that the R₂ group may form a ring with a carbon atom to which the R₂ group is attached or to an adjacent carbon atom or may represent a point of crosslinking;
X independently represents a hydrogen atom, an alkyl group, an amino group or a metal atom;
a independently represents an integer ranging from 1 to 1000;
b independently represents an integer ranging from 1 to 1000;
c independently represents an integer ranging from 1 to 1000;
d independently represents an integer ranging from 1 to 1000; and
e independently represents an integer ranging from 1 to 1000.
17, The process of Paragraph 1, comprising contacting the amphiphilic copolymer with at least one of:
   a milk of lime comprising calcium hydroxide;
   a dispersion comprising a precipitated calcium carbonate;
   a filter cake comprising a precipitated calcium carbonate; and
   a powder comprising calcium carbonate particles.
18. The process of Paragraph 1, comprising:
   contacting the amphiphilic copolymer with the calcium carbonate or precursor thereof in a liquid medium, to obtain a dispersion of the surface-modified calcium carbonate; and
   removing the liquid medium from the dispersion to obtain a powder of the
   surface-modified calcium carbonate.
19, The process of Paragraph 1, wherein the calcium carbonate or precursor thereof is contacted with an aqueous dispersion of the amphiphilic copolymer or a salt thereof.
20. The process of Paragraph 1, further comprising contacting the calcium carbonate or precursor thereof with at least one additional surface-modifying agent.
21. The process of Paragraph 1, further comprising contacting the calcium carbonate or precursor thereof with at least one fatty acid compound or salt or derivative thereof.
22. The process of Paragraph 1, wherein a molar ratio of the hydrophilic subunits to the hydrophobic subunits in the amphiphilic copolymer ranges from about 20:80 to about 80:20.
23. The process of Paragraph 1, wherein a mass ratio of the amphiphilic copolymer to the calcium carbonate or precursor thereof ranges from about 0.01:99.99 to about 5.0:95.0.
24. A surface-modified calcium carbonate obtained by the process of Paragraph 1.
25. The surface-modified calcium carbonate of Paragraph 24, wherein:
   particles of the surface-modified calcium carbonate are in the form of a core-shell structure comprising a calcium carbonate core and a shell derived from the amphiphilic copolymer, said shell at least partially coating the calcium carbonate core; and
   the shell is ionically bonded to the calcium carbonate core via deprotonated acid groups of the hydrophilic subunits.
26. The surface-modified calcium carbonate of Paragraph 24, having a BET surface area of equal to or greater than 30.0 m²/g.
27. The surface-modified calcium carbonate of Paragraph 24, having an average particle size (d₅₀) of equal to or less than 0.75 μm.
28. The surface-modified calcium carbonate of Paragraph 24, having a moisture uptake of equal to or less than 2.0%,
29. The surface-modified calcium carbonate of Paragraph 24, having a moisture content of equal to or less than 35%.
30. A composition, comprising the surface-modified calcium carbonate of Paragraph 24, wherein the composition is selected from the group consisting of a polymer, a paint, a coating, a sealant and a color modifying agent.
   Embodiments of the present disclosure may be as defined in the following numbered statements:
1. A process for producing a surface-modified calcium carbonate, the process comprising contacting a calcium carbonate or precursor thereof with at least one amphiphilic copolymer comprising hydrophilic subunits and hydrophobic subunits, wherein:
   the hydrophilic subunits derive from at least one ethylenically-unsaturated compound comprising a carboxylic acid group or salt or derivative thereof;
   the hydrophobic subunits derive from at least one ethylenically-unsaturated compound comprising a hydrophobic group; and
   the amphiphilic copolymer has a hydrophilic-lipophilic balance value ranging from about 1 to about 40.
2. The process of statement 1, wherein:
   the hydrophilic subunits derive from maleic acid or maleic anhydride; and
   the hydrophobic subunits derive from diisobutylene and/or wherein the calcium carbonate is a precipitated calcium carbonate or a ground calcium carbonate.
3. The process of Statement 1 or Statement 2, wherein the hydrophilic subunits derive from at least one carboxyl group-containing vinyl monomer, and/or wherein the hydrophilic subunits derive from at least one carboxyl group-containing monomer selected from the group consisting of a (meth)acrylic acid or salt or derivative thereof, an unsaturated polybasic acid or salt or derivative thereof, and mixtures thereof, or wherein the hydrophilic subunits derive from at least one carboxyl group-containing monomer selected from the group consisting of acrylic acid, an alkylacrylic acid, an allyl malonic acid, an allyl succinic acid, a butenoic acid, a cinnamic acid, a citriconic acid, a crotonic acid, a glutaconic acid, an itaconic acid, a maleic acid, a fumaric acid, a mesaconic acid, a succinic acid and salts or derivatives thereof, or wherein the hydrophilic subunits derive from maleic acid, a salt or derivative of maleic acid, or a combination thereof.
4. The process of any one of the preceding Statements, wherein the hydrophobic group comprises an alkane group, an alkene group, an ether group, a sulfide group, an ester group, an imide group, a sulfonate group, a phosphonate group, or combinations thereof, and/or wherein the hydrophobic subunits derive from an aliphatic or alicyclic olefin-containing compound, a (meth)acrylate compound, a vinyl aromatic compound, a vinyl ester compound, a (meth)acrylonitrile compound, a vinyl halide compound, a vinyl ether compound, a (meth)acrylamide compound, or a combination thereof, optionally wherein the hydrophobic subunits derive from at least one ethylenically-unsaturated compound selected from the group consisting of ethylene, propylene, 1-butene, 2-butene, isobutylene, diisobutylene, 1-pentene, 1-hexene, 1-heptene, 1-octene, 1-nonene, 1-decene, 2-pentene, 3-pentene, propylene tetramer; isobutylene trimer, 1,2-butadiene, 1,3-butadiene, 1,2-pentadiene, 1,3-pentadiene, 1,4-pentadiene, isoprene, 5-hexadiene, 2-methyl-5-propyl-1-hexene, 4-octene and 3,3-dimethyl-1-pentene.
5. The process of any one of the preceding Statements, wherein the amphiphilic copolymer further comprises at least one additional subunit derived from an ethylenically-unsaturated compound comprising a polar group, optionally wherein the amphiphilic copolymer further comprises at least one additional subunit derived from an ethylenically-unsaturated compound comprising a halide group, a hydroxyl group, a nitrile group, a nitro group, a sulfonic acid group or a phosphonic acid group, optionally wherein the amphiphilic copolymer further comprises at least one additional subunit derived from a sulfonic acid group-containing vinyl monomer, an acidic phosphate-containing vinyl monomer, a methylol-group-containing vinyl monomer, or a mixture thereof.
6. The process any one of the preceding Statements, wherein the amphiphilic copolymer is a crosslinked copolymer.
7. The process of any one of the preceding Statements, wherein the amphiphilic copolymer is an alternating copolymer comprising alternating hydrophilic and hydrophobic subunits.
8. The process of any one of the preceding Statements, wherein the amphiphilic copolymer comprises a polymer unit represented by the formula (i), (II) or (III):

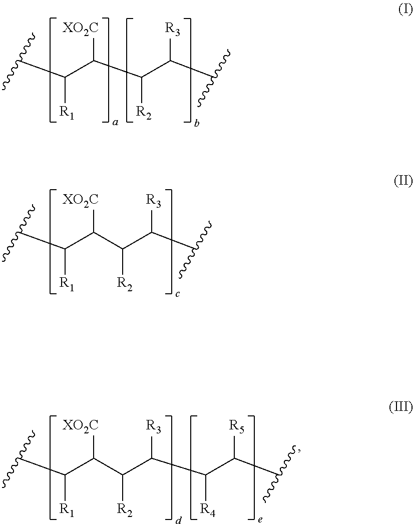

wherein:
R₁ independently represents a hydrogen atom, an aliphatic group, an alicyclic group, an aromatic group, a heterocyclic group, or a carboxylic acid group or derivative or salt thereof, with the proviso that the R₁ group may form a ring with a carbon atom that is α, β or γ relative to the —CO₂X group or may represent a point of crosslinking;
R₂ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₃ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₄ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₅ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
X independently represents a hydrogen atom, an alkyl group, an amino group or a metal atom;
a independently represents an integer ranging from 1 to 1000;
b independently represents an integer ranging from 1 to 1000;
c independently represents an integer ranging from 1 to 1000;
d independently represents an integer ranging from 1 to 1000; and
e independently represents an integer ranging from 1 to 1000.
9. The process of any one of the preceding Statements, comprising contacting the amphiphilic copolymer with at least one of:
   a milk of lime comprising calcium hydroxide;
   a dispersion comprising a precipitated calcium carbonate;
   a filter cake comprising a precipitated calcium carbonate; and
   a powder comprising calcium carbonate particles.
10. The process of any one of the preceding Statements, comprising:
   contacting the amphiphilic copolymer with the calcium carbonate or precursor thereof in a liquid medium, to obtain a dispersion of the surface-modified calcium carbonate; and
   removing the liquid medium from the dispersion to obtain a powder of the
   surface-modified calcium carbonate.
11. The process of any one of the preceding Statements, wherein the calcium carbonate or precursor thereof is contacted with an aqueous dispersion of the amphiphilic copolymer or a salt thereof, and/or further comprising contacting the calcium carbonate or precursor thereof with at least one additional surface-modifying agent, and/or further comprising contacting the calcium carbonate or precursor thereof with at least one fatty acid compound or salt or derivative thereof.
12, The process of any one of the preceding Statements, wherein a molar ratio of the hydrophilic subunits to the hydrophobic subunits in the amphiphilic copolymer ranges from about 20:80 to about 80:20 and/or wherein a mass ratio of the amphiphilic copolymer to the calcium carbonate or precursor thereof ranges from about 0.01:99.99 to about 5.0:95.0.
13. A surface-modified calcium carbonate obtained by the process of Statement 1, optionally wherein:
   particles of the surface-modified calcium carbonate are in the form of a core-shell structure comprising a calcium carbonate core and a shell derived from the amphiphilic copolymer, said shell at least partially coating the calcium carbonate core: and
   the shell is ionically bonded to the calcium carbonate core via deprotonated acid groups of the hydrophilic subunits.
14, The surface-modified calcium carbonate of Statement 13, having a feature selected from: (i) a BET surface area of equal to or greater than 30.0 m²/g, (ii) an average particle size (d₅₀) of equal to or less than 0.75 μm, (iii) a moisture uptake of equal to or less than 2.0% and (iv) a moisture content of equal to or less than 35%.
15. A composition, comprising the surface-modified calcium carbonate of Statement 13 or Statement 14, wherein the composition is selected from the group consisting of a polymer, a paint, a coating, a sealant and a color modifying agent.

The above description is presented to enable a person skilled in the art to make and use the invention, and is provided in the context of a particular application and its requirements. Various modifications to the embodiments disclosed herein will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the disclosure may not show every benefit of the invention, considered broadly.

1. A process for producing a surface-modified calcium carbonate, the process comprising mixing a calcium carbonate or precursor thereof with at least one amphiphilic copolymer comprising hydrophilic subunits and hydrophobic subunits, wherein:
the hydrophilic subunits derive from at least one ethylenically-unsaturated compound comprising a carboxylic acid group or salt or derivative thereof;
the hydrophobic subunits derive from at least one ethylenically-unsaturated compound comprising a hydrophobic group; and
the amphiphilic copolymer has a hydrophilic-lipophilic balance value ranging from about 1 to about 40, wherein the amphiphilic copolymer is a crosslinked copolymer.

2. The process of claim 1, wherein:
the hydrophilic subunits derive from maleic acid or maleic anhydride; and
the hydrophobic subunits derive from diisobutylene and/or wherein the calcium carbonate is a precipitated calcium carbonate.

3. The process of claim 1, wherein the hydrophilic subunits derive from at least one carboxyl group-containing vinyl monomer, and/or wherein the hydrophilic subunits derive from at least one carboxyl group-containing monomer selected from the group consisting of a (meth)acrylic acid or salt or derivative thereof, an unsaturated polybasic acid or salt or derivative thereof, and mixtures thereof, or wherein the hydrophilic subunits derive from at least one carboxyl group-containing monomer selected from the group consisting of acrylic acid, an alkylacrylic acid, an allyl malonic acid, an allyl succinic acid, a butenoic acid, a cinnamic acid, a citriconic acid, a crotonic acid, a glutaconic acid, an itaconic acid, a maleic acid, a fumaric acid, a mesaconic acid, a succinic acid and salts or derivatives thereof, or wherein the hydrophilic subunits derive from maleic acid, a salt or derivative of maleic acid, or a combination thereof.

4. The process of claim 1, wherein the hydrophobic group comprises an alkane group, an alkene group, an ether group, a sulfide group, an ester group, an imide group, a sulfonate group, a phosphonate group, or combinations thereof, and/or wherein the hydrophobic subunits derive from an aliphatic or alicyclic olefin-containing compound, a (meth)acrylate compound, a vinyl aromatic compound, a vinyl ester compound, a (meth)acrylonitrile compound, a vinyl halide compound, a vinyl ether compound, a (meth)acrylamide compound, or a combination thereof, optionally wherein the hydrophobic subunits derive from at least one ethylenically-unsaturated compound selected from the group consisting of ethylene, propylene, 1-butene, 2-butene, isobutylene, diisobutylene, 1-pentene, 1-hexene, 1-heptene, 1-octene, 1-nonene, 1-decene, 2-pentene, 3-pentene, propylene tetramer; isobutylene trimer, 1,2-butadiene, 1,3-butadiene, 1,2-pentadiene, 1,3-pentadiene, 1,4-pentadiene, isoprene, 5-hexadiene, 2-methyl-5-propyl-1-hexene, 4-octene and 3,3-dimethyl-1-pentene.

5. The process of claim 1, wherein the amphiphilic copolymer further comprises at least one additional subunit derived from an ethylenically-unsaturated compound comprising a polar group, optionally wherein the amphiphilic copolymer further comprises at least one additional subunit derived from an ethylenically-unsaturated compound comprising a halide group, a hydroxyl group, a nitrile group, a nitro group, a sulfonic acid group or a phosphonic acid group, optionally wherein the amphiphilic copolymer further comprises at least one additional subunit derived from a sulfonic acid group-containing vinyl monomer, an acidic phosphate-containing vinyl monomer, a methylol-group-containing vinyl monomer, or a mixture thereof.

6. The process of claim 1, wherein the amphiphilic copolymer is a crosslinked copolymer.

7. The process of claim 1, wherein the amphiphilic copolymer is an alternating copolymer comprising alternating hydrophilic and hydrophobic subunits.

8. The process of claim 1, wherein the amphiphilic copolymer comprises a polymer unit represented by the formula (I), (II) or (III): 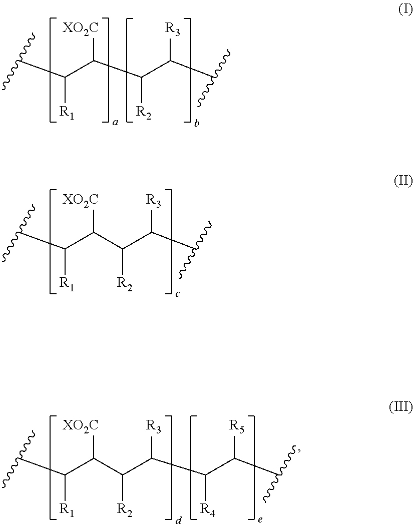
wherein:
R₁ independently represents a hydrogen atom, an aliphatic group, an alicyclic group, an aromatic group, a heterocyclic group, or a carboxylic acid group or derivative or salt thereof, with the proviso that the R₁ group may form a ring with a carbon atom that is α, β or γ relative to the —CO₂X group or may represent a point of crosslinking;
R₂ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₃ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₄ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
R₅ independently represents a hydrogen atom, an aliphatic group, an alicyclic group, an aromatic group, a heterocyclic group, an alkene-containing group, an ether-containing group, an ester-containing group, a sulfide-containing group, an imide-containing group, a sulfonate or sulfonic-containing group, a phosphonate or phosphonic-containing group, a nitrile-containing group, a nitro-containing group, a hydroxyl-containing group, or a halide-containing group, with the proviso that the R₂ group may form a ring with a carbon atom to which the R₂ group is attached or to an adjacent carbon atom or may represent a point of crosslinking;
X independently represents a hydrogen atom, an alkyl group, an amino group or a metal atom;
a independently represents an integer ranging from 1 to 1000;
b independently represents an integer ranging from 1 to 1000;
c independently represents an integer ranging from 1 to 1000;
d independently represents an integer ranging from 1 to 1000; and
e independently represents an integer ranging from 1 to 1000.

9. The process of claim 1, comprising contacting the amphiphilic copolymer with at least one of:
a milk of lime comprising calcium hydroxide;
a dispersion comprising a precipitated calcium carbonate; and
a filter cake comprising a precipitated calcium carbonate;

10. The process of claim 1, comprising:
contacting the amphiphilic copolymer with the calcium carbonate or precursor thereof in a liquid medium, to obtain a dispersion of the surface-modified calcium carbonate; and
removing the liquid medium from the dispersion to obtain a powder of the surface-modified calcium carbonate.

11. The process of claim 1, wherein the calcium carbonate or precursor thereof is contacted with an aqueous dispersion of the amphiphilic copolymer or a salt thereof, and/or further comprising contacting the calcium carbonate or precursor thereof with at least one additional surface-modifying agent, and/or further comprising contacting the calcium carbonate or precursor thereof with at least one fatty acid compound or salt or derivative thereof.

12. The process of claim 1, wherein a molar ratio of the hydrophilic subunits to the hydrophobic subunits in the amphiphilic copolymer ranges from about 20:80 to about 80:20 and/or wherein a mass ratio of the amphiphilic copolymer to the calcium carbonate or precursor thereof ranges from about 0.01:99.99 to about 5.0:95.0.

13. A surface-modified calcium carbonate obtained by the process of claim 1, optionally wherein:
particles of the surface-modified calcium carbonate are in the form of a core-shell structure comprising a calcium carbonate core and a shell derived from the amphiphilic copolymer, said shell at least partially coating the calcium carbonate core; and
the shell is ionically bonded to the calcium carbonate core via deprotonated acid groups of the hydrophilic subunits.

14. The surface-modified calcium carbonate of claim 13, having a feature selected from: (i) a BET surface area of equal to or greater than 30.0 m²/g, (ii) an average particle size (d₅₀) of equal to or less than 0.75 μm, (iii) a moisture uptake of equal to or less than 2.0% and (iv) a moisture content of equal to or less than 35%.

15. A composition, comprising the surface-modified calcium carbonate of claim 13, wherein the composition is selected from the group consisting of a polymer, a paint, a coating, a sealant and a color modifying agent.

16. A process according to claim 1, wherein the precursor is selected from the group consisting of aragonite, calcite, dolomite, precipitated calcium carbonate (PCC), limestone, chalk marble, or mixtures thereof.
